(19) United States
(12) Patent Application Publication
(10) Pub. No.: US 2006/0020632 A1
(43) Pub. Date: Jan. 26, 2006

(54) Method of increasing productivity in organization

(76) Inventors: Boung-Il Choi, Hwaseong-si (KR); Je-Eung Park, Suwon-si (KR); Mi-Ri Lee, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/184,838

(22) Filed: Jul. 20, 2005

(30) Foreign Application Priority Data
Jul. 23, 2004 (KR) 2004-57464

(51) Int. Cl. G06F 17/00

(52) U.S. Cl. 707/104.1

(57) ABSTRACT

A method of increasing productivity in an organization by sharing praise, encouragement, recognition, and gratitude among members of the organization, wherein the method also provides virtual space for the members to exchange and share inspirational messages.

### BACKGROUND

The present invention generally relates to an electronic network system. More particularly, the present invention relates to a method of increasing productivity in an organization by delivering inspirational messages and encouragement to employees through an electronic network system.

A claim of priority is made to Korean Patent Application 2004-57464, filed on Jul. 23, 2004, the contents of which are hereby incorporated by reference in their entirety.

In general, a person has at least one or more occupations during his/her lifetime. Type of occupations include a range of positions in small, medium, and large sized companies; local, State, and Federal governments, as well as professional positions such as doctors and lawyers and self-employed positions such as shopkeepers, restaurateurs, and service professionals. Work within the context of these diverse occupations is generally characterized by clear objectives, assignments and/or goals.

Employee moral, effective employee motivation and corresponding feedback and evaluation procedures have been the subject of a great deal of study and experimentation. Employees and potential employees are keenly interested in a positive work environment. Some employees define a positive work environment as one in which the company provides a proper business environment and sufficient compensation. Others define a positive work environment as in terms of professional growth potential. Still others define a positive work environment in terms of job security, workplace stability, and/or employment tenure.

The importance of a positive working environment to the overall success of any enterprise is annually highlighted by publication of a top 100 “Best Places to Work” list in Fortune Magazine. The companies identified on this list become models or benchmarks for other companies, and their internal procedures are widely emulated.

Recently, many companies have re-focused their attention on employee moral with programs and slogans that seek to recognize employees as quasi-family members with the organization. Nonetheless, the implementation of employee-motivating programs and themes with lasting positive effects has proved difficult.

In contrast, the employees of companies having a well-established reputation for a positive working environment tend to trust the company's management, take pride in work and the company, and enjoy working with their colleagues. Yet, the companies enjoying such a reputation lack any one system, policy or approach that may be identified for the overall good feelings exhibited by their employees. However, one truism does emerge from a review of companies having strong reputations for a positive working environment. That is, these companies all enjoy a high level of positive internal relationships.

The term “internal relationships” encompasses at least relationships between employees and their individual superiors, relationships between employees and the company as a whole, and relationships between peer colleagues. In a company enjoying a strong reputation for a positive work environment, internal relationships are characterized by trust, pride, and honest personal interest.

Viewing this issue from another perspective, attempts to generate a positive work environment and a consistently strong reputation for same, must include efforts to establish trust between employees and management, build pride for the business and company, and develop positive peer dynamics. One effective mechanism for accomplishing all of these purposes recognizes the motivating and beneficial effects of consistently expressing praise and encouragement, as well as exhibiting consideration, gratitude, and respect with the company.

### SUMMARY

In an embodiment of the present invention, a method of increasing productivity in an organization by providing a service adapted to share inspirational messages among members of an organization by providing a first platform in communication with a second platform, wherein the second platform comprises an index server, responsive to a first input by a user on the first platform displaying an introduction menu on the first platform, and, responsive to a second input by the user on the first platform displaying an inspirational menu on the first platform.

In another embodiment, a method of increasing productivity in an organization by providing a service adapted to share inspirational messages among members of an organization by providing a first platform in communication with a second platform, wherein the second platform comprises an index server, responsive to a first input by a user on the first platform displaying an introduction menu on the first platform, responsive to a second input by the user on the first platform displaying an inspirational menu on the first platform, and, responsive to a third input by the user on the first platform displaying a stored inspirational message.

In another embodiment, a method of increasing productivity in an organization by providing a service adapted to share inspirational messages among members of an organization by responsive to a first input by a user on a first platform, communicating between the first platform to a second platform, wherein the second platform comprises an index server and a database displaying an introduction menu on the first platform, retrieved from the database responsive to a second input by the user on the first platform displaying an empty inspirational message form, retrieved from the database responsive to a third input by the user, and storing an inspirational message inputted by the user onto the empty inspirational message form.

### BRIEF DESCRIPTION OF THE DRAWINGS

The present invention will be understood upon consideration of several exemplary embodiments described below with reference to the accompanying drawings, in which:

FIG. 1 is a block diagram for a network service in accordance with an embodiment of the present invention;

FIG. 2 is a flow chart to illustrate a method of registering as a user for the first time;

FIG. 3 is a flow chart illustrates a method of writing an inspirational message;

FIG. 4A illustrates an example of an inspiration index home page;

FIG. 4B illustrates an example of an inspirational main menu;

FIG. 4C illustrates an example of a background picture selection menu;

FIG. 4D illustrates an example of an inspirational write screen;

FIG. 4E illustrates an example of inspirational message list for an individual user;

FIG. 5 is a flow chart illustrating a method of a confirming a receipt of an inspirational message;

FIG. 6A illustrates an example of an inspirational message list;

FIG. 6B illustrates an example of contents of received inspirational messages;

FIG. 7 is a flowchart illustrating a method of confirming the receipt of inspirational message addressed to another person;

FIG. 8A illustrates an example of an inquiry screen for another person's inspirational messages;

FIG. 8B illustrates an example of inquiry result list for another person inspirational messages;

FIG. 8C illustrates an example for contents of another person inspirational messages;

FIG. 9 is a flowchart illustrating a method of confirming an individual inspirational index;

FIG. 10A illustrates an example of inquiry screen for an individual inspirational index;

FIG. 10B illustrates an example of inquiry result screen for an individual inspirational index;

FIG. 11 is a flowchart illustrating a method of confirming a group inspirational index;

FIG. 12A illustrates an example of inquiry screen for a group inspirational index;

FIG. 12B illustrates an example of inquiry result screen for a group inspirational index;

FIG. 13 is a flowchart illustrating a method of confirming each group inspirational message trend;

FIG. 14A illustrates an example of inquiry screen for a group inspirational trend;

FIG. 14B illustrates an example of inquiry result screen for each group inspirational trend;

FIG. 15 is a graph of result index illustrating a change state of the total presentation number of business improvement;

FIG. 16 is a graph of result index illustrating a change of the execution number of business improvement;

FIG. 17 is a graph of result index illustrating a change state of the total award amount grant of business improvement;

FIG. 18 is a graph of result index illustrating a change of production result; and

FIG. 19 is a graph of result index illustrating a change state of middle evaluation result for a satisfaction degree of employees.

### DESCRIPTION OF EXEMPLARY EMBODIMENT(S)

Embodiments of the invention will now be described with reference to the accompanied drawings in which like reference numbers refer to the same or similar elements throughout the specification. Those of ordinary skill in the art will understand the embodiments described are merely teaching example. The invention may be implemented in numerous different ways and is not limited to only the described embodiments.

Embodiments of the invention describe a method of providing a virtual message space with in an organization's an electronic network, computer system, intranet, etc. (hereafter “network”) in which organization members may convey messages of inspiration, gratitude, encouragement, and recognition.

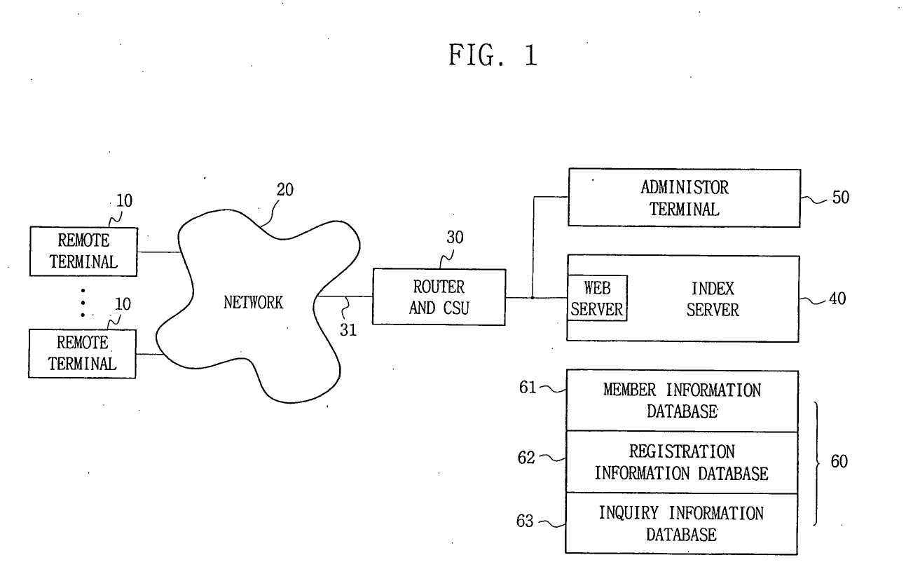

Figure (FIG.) 1 is a general block diagram of one embodiment of the invention. In FIG. 1, an index server 40 comprises a conventional server platform adapted to assess the worldwide web and manage a one or more of associated databases. Index server 40 performs message registration, message confirmation, sender confirmation, and also controls and performs individual inspirational index confirmation and group praise index confirmation in relation to posted messages. An administrator terminal 50 is typically connected to index server 40 through, for example, a Local Area Network (LAN), in order to control and maintain index server 40, to develop and manage programs, and to update data stored in index server 40 or an associated database. A conventional router or Channel Service Unit (CSU) 30 is connected to index server 40 through the LAN.

A plurality of conventional terminals 10 are connected through network 20 to index server 40. Organization members may send and receive messages (or message confirmations), whether such messages are individually directed or group directed; via a connected terminal 10. Additionally, the index server may provide statistical indications regarding messages sent/received, trends in messaging, etc.

The invention is adapted to many different kinds of physical connections between system elements, including wireless as well as hard-wired connections. For example, the respective connections between index server 40 and the plurality of terminals 10 (collectively or singularly) may be wholly or partially formed by a modem connection, the Public Switched Telephone Network (PSTN), a private connection, an Integrated Services Digital Network (ISDN), and a wireless connection, a microwave link, and/or a satellite communication network. Each one of the plurality of terminals 10 may be a Personal Computer (PC, either laptop or desktop), a Personal Digital Assistance (PDA), or even a cellular telephone. For the sake of simplicity, the embodiment descriptions that follow assume terminal 10 is a PC.

As connected to index server 40 through network 20, each terminal 10 may access a homepage provided by the integrated web server. In the present embodiment, index server 40 comprises software applications adapted to access a member information database 61, a registration information database 62, and/or an inquiry information database 63. Index server 40 may take the form of a dedicated, stand-alone server or it may be implemented within a general provision server.

Member information database 61 stores data and is adapted to operation with related software applications in order to register organization members. Registration information database 62 stores registration information and introduction information related to an inspirational index. Inquiry information database 63 stores information for each registered organization member, typically indicates a number of messages (read or unread), as well as providing functionality to segregate, output and track individual verses group index information. Collectively member information database 61, registration information database 62 and Inquiry information database 63 are referred to as data base 60.

Terminal 10 generally has an operating system (OS), such as a Windows NT 4.0K with a IIS web server 4.0 and Microsoft Transaction Server (MTS), but may also operate under Windows XP, WIN 95/98, WINDOWS 2000, or LINUX environment. Index server 40 preferably includes a web server and a Data Base Management System (DBMS). The DBMS, for example, can be a MS-SQL server 7.0 with related component such as an Active Data Object (ADO) 2.0 component for a DB access. Hardware used for the system preferably includes, a web server, network equipment, hub and router, and Internet service lines.

The web server is preferably managed by a Local Area Network (LAN) or a workstation. Database 60 is preferably a hard disk, an optic storage, a CD-ROM drive, or a flash memory. Database 60 stores inspirational message and various data related to the registration information service.

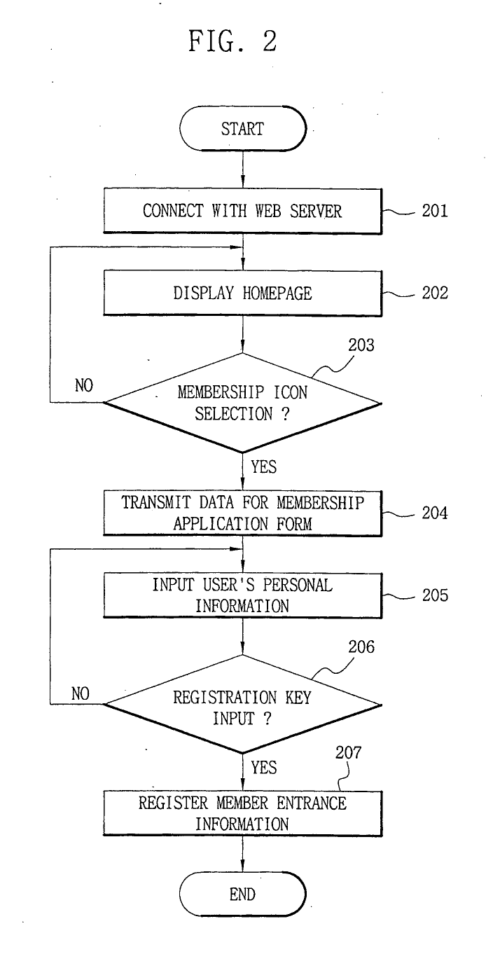

FIG. 2 is a flow chart illustrating one exemplary method for registering as a first time user. Reference to FIG. 1 will be made in the discussion of FIG. 2.

Within the context of the exemplary method illustrated in FIG. 2, an organization member logs on to a terminal 10 and connects to index server 40 (201). For convenience, the organization member (e.g. an employee) will be referred to as the “user” throughout the specification. Once the user is connected, index server 40 transmits reset main screen data stored in information registration database 62 through network 20. This data is then presented on a visual (or audio) display associated with terminal 10 (202). With a main (or log-in) screen displayed, the user may select a new membership icon. In response to this indication, index server 40 continues forward with a new membership procedure (203). Index server 40 then retrieves data for a new membership application form member information database 61 (204). The user is then able to input his/her personal information and/or generally interact with the new membership application (205). Until the user has input his/her personal information, index server 40 awaits the user's indication of a registration key, upon which the new membership process continues (206). Upon receipt of the registration key indication, index server 40 registers the user as a new organization member and stores the associated personal information in the member information database 61 (207).

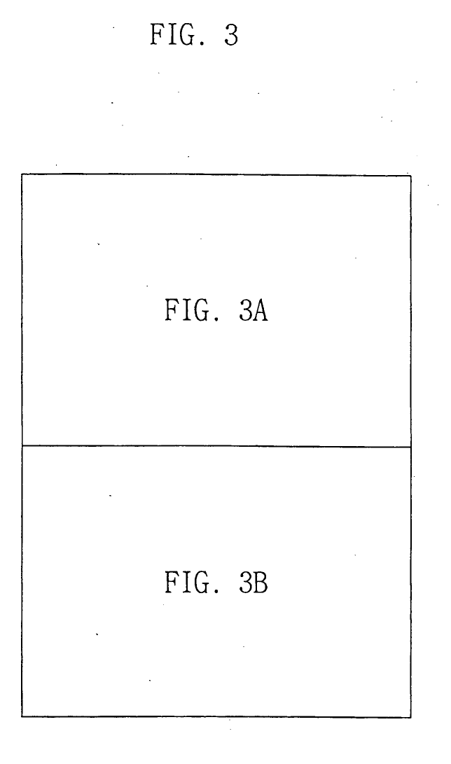

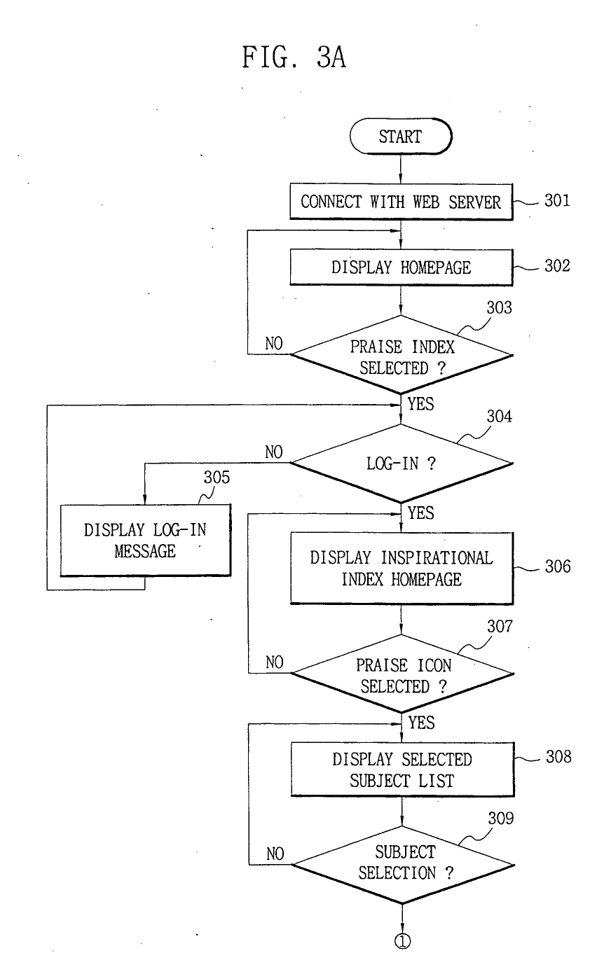

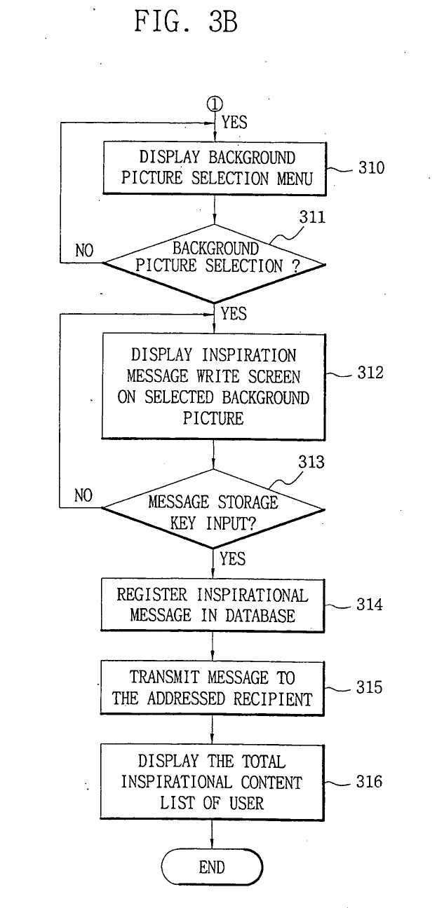

FIG. 3, comprising FIGS. 3A and 3B, is a flow chart illustrating an exemplary a method of writing an inspirational message within the context of the foregoing embodiment.

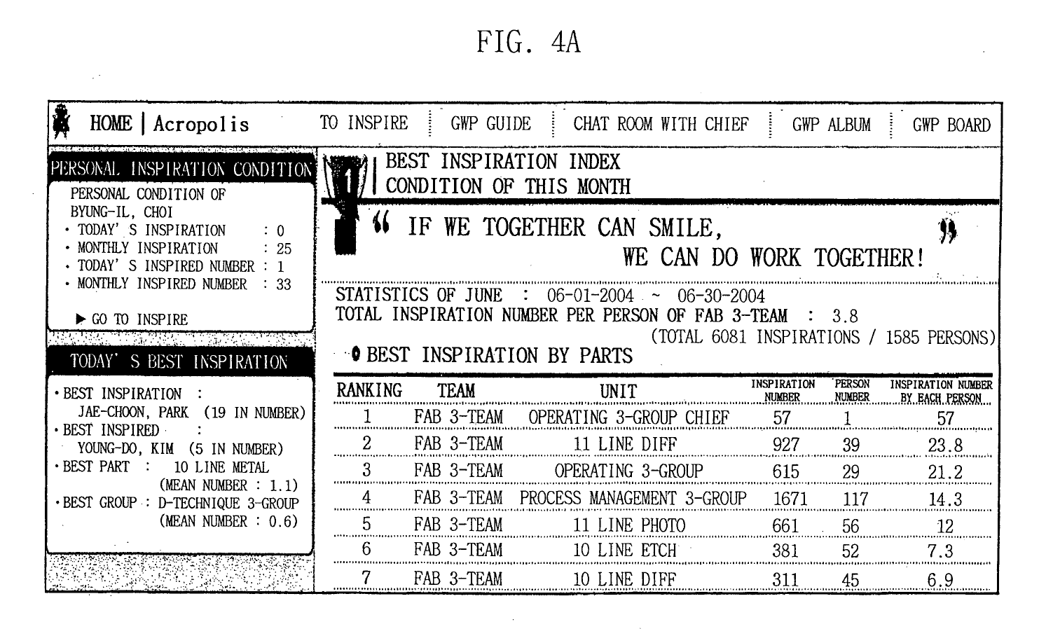

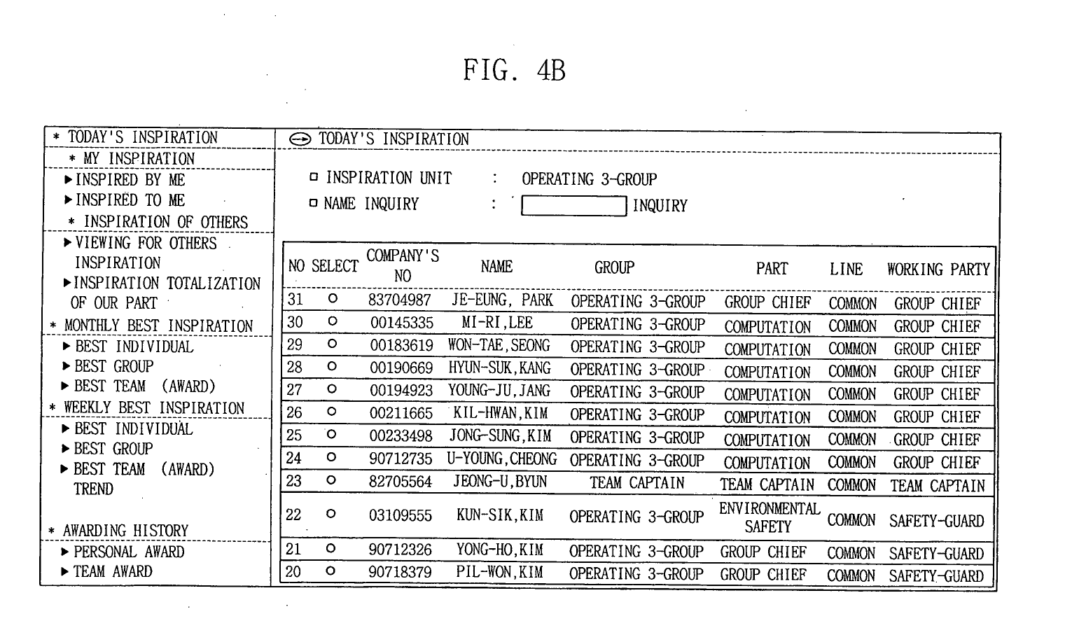

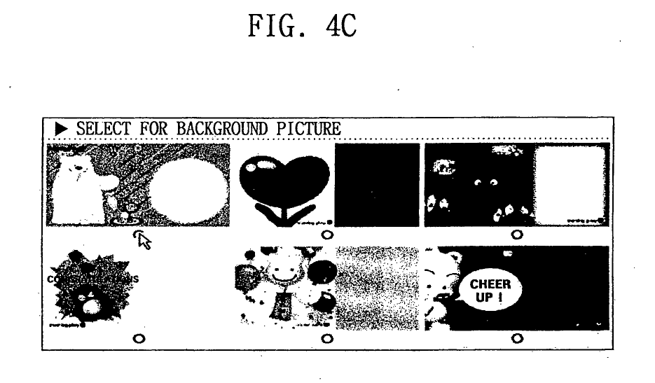

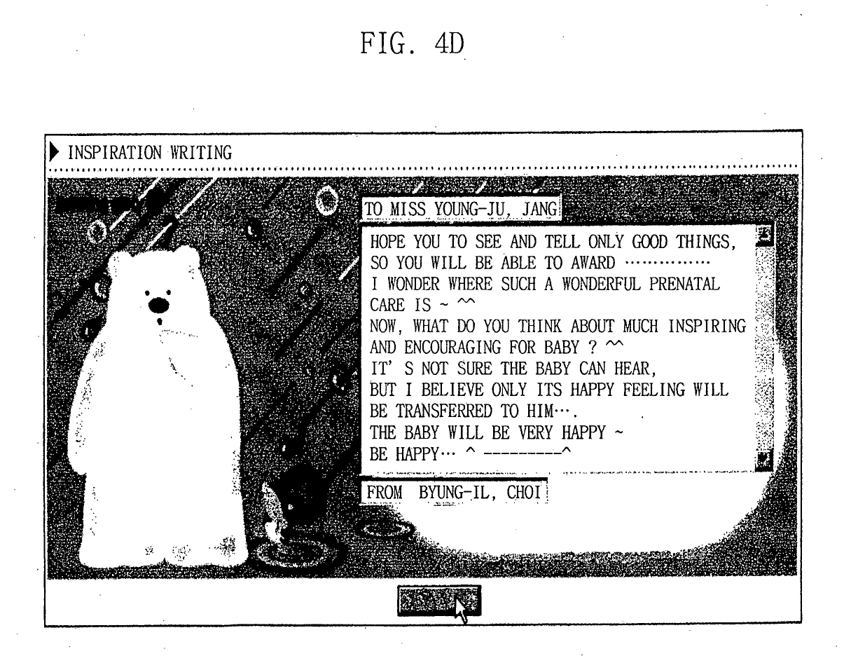

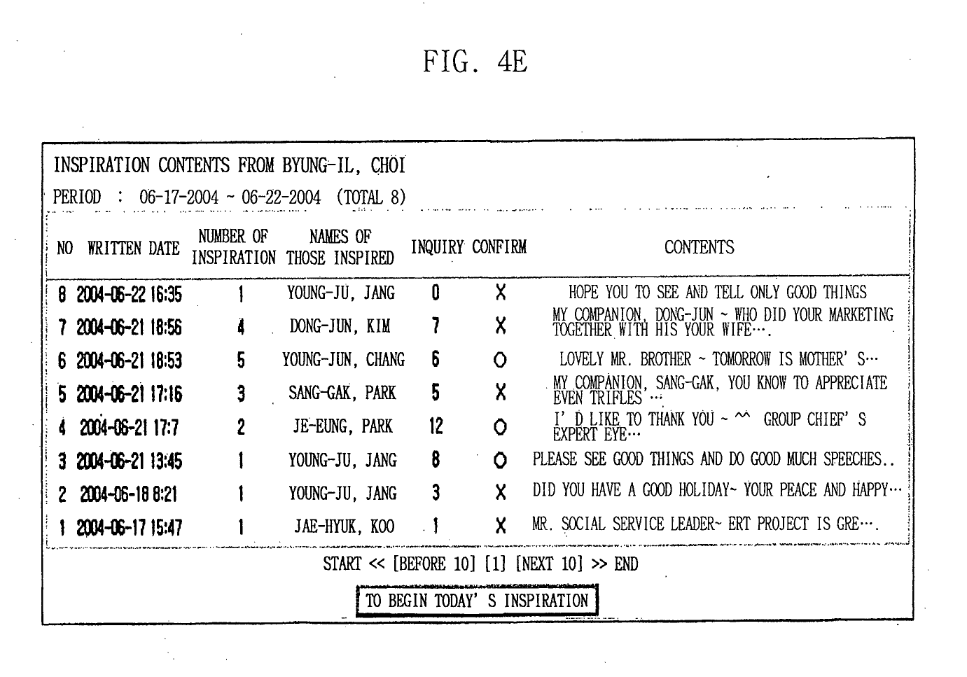

A user first connects to an inspirational message index associated, for example, with a homepage displayed on terminal 10 (310, 302). At this time, the user may select a screen icon associated with the inspirational message index. Upon receiving an indication that the inspirational message index icon has been selected, index server 40 next determines whether the user is appropriately logged-in (304). If not, a log-in message is displayed on terminal 10 (305). Where the user is logged-in, index server 40 displays the inspirational index homepage screen data on terminal 10 and retrieves related data form information database 62 (306). The screen display shown in FIG. 4A is one example of a possible inspirational index homepage screen.

At this time, the user may select a message icon from amongst a range of possible menus and lists appearing on the inspirational index homepage screen. One such message icon is generically referred to as a praise icon. When the praise icon is selected (307), the process continues and subject information corresponding to various messages (e.g., inspirational or positive feedback messages) is displayed on terminal 10 (308). This information may be retrieved, for example, from member information database 61. This subject information may be displayed, for example, in a manner like that shown in FIG. 4B.

The user may now select a desired message subject from the displayed list of possible messages (309). Further, the user may search the displayed list of messages by context using a search or inquiry icon appearing in the screen. Once a message has been selected, index server 40 then displays a background picture selection menu on terminal 10 by retrieving relevant data form registration information database 62. This background picture selection menu may be similar to the one shown in FIG. 4C.

The user may now select a desired background picture from a background picture selection menu (310, 311). Once a background picture has been selected, index server 40 displays a message write screen with the selected background picture retrieved from registration information database 62 (312). See, e.g., the screen display shown in FIG. 4D. The user may then type an inspirational message appropriate to the intended audience in view of the selected message subject and background picture (313). The resulting inspiration message may then be registered in the registration information database (314). Index server 40 then transmits the inspirational message to the intended recipient(s) (315). Following transmission of the inspirational message, the system tallies a count of messages sent based on the number of recipients (individua0l or group) receiving the transmitted message, and thereafter provides user feedback in the form of an inspirational content list which may be displayed on the user's terminal (316). See, e.g., the screen display shown in FIG. 4E.

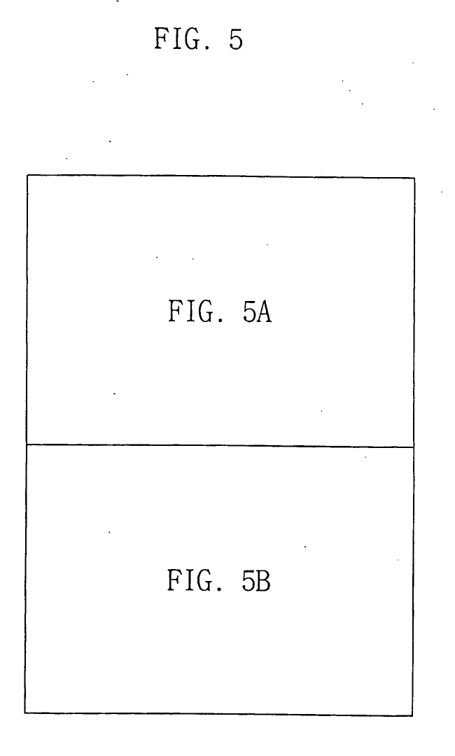

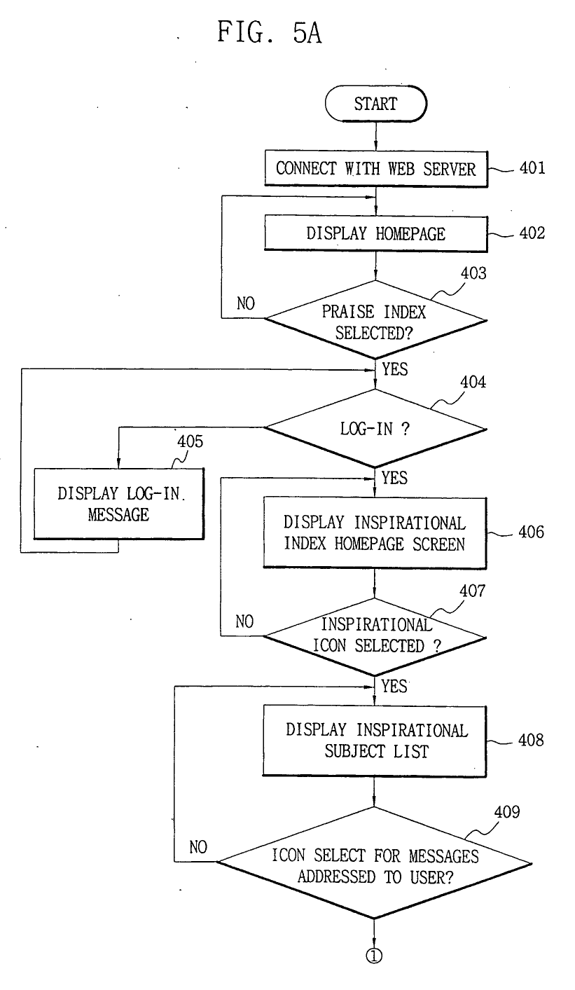

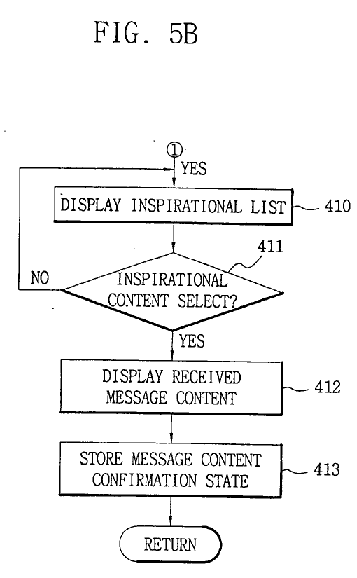

FIG. 5, comprising FIGS. 5A and 5B, is a flow chart illustrating an exemplary method for confirming receipt of an inspirational message.

A user first connects to an inspirational message index associated, for example, with a homepage displayed on terminal 10 (410, 402). At this time, the user may select a screen icon associated with the inspirational message index. Upon receiving an indication that the inspirational message index icon has been selected, index server 40 next determines whether the user is appropriately logged-in (404). If not, a log-in message is displayed on terminal 10 (405). Where the user is logged-in, index server 40 displays the inspirational index homepage screen data on terminal 10 and retrieves related data form information database 62 (406). The screen display shown in FIG. 4A is one example of a possible inspirational index homepage screen.

At this time, the user may select a message icon from amongst a range of possible menus and lists appearing on the inspirational index homepage screen. One such message icon is generically referred to as a praise icon. When the praise icon is selected (407), the process continues and subject information corresponding to various messages (e.g., inspirational or positive feedback messages) is displayed on terminal 10 (408). This information may be retrieved, for example, from member information database 61. This subject information may be displayed, for example, in a manner like that shown in FIG. 4B.

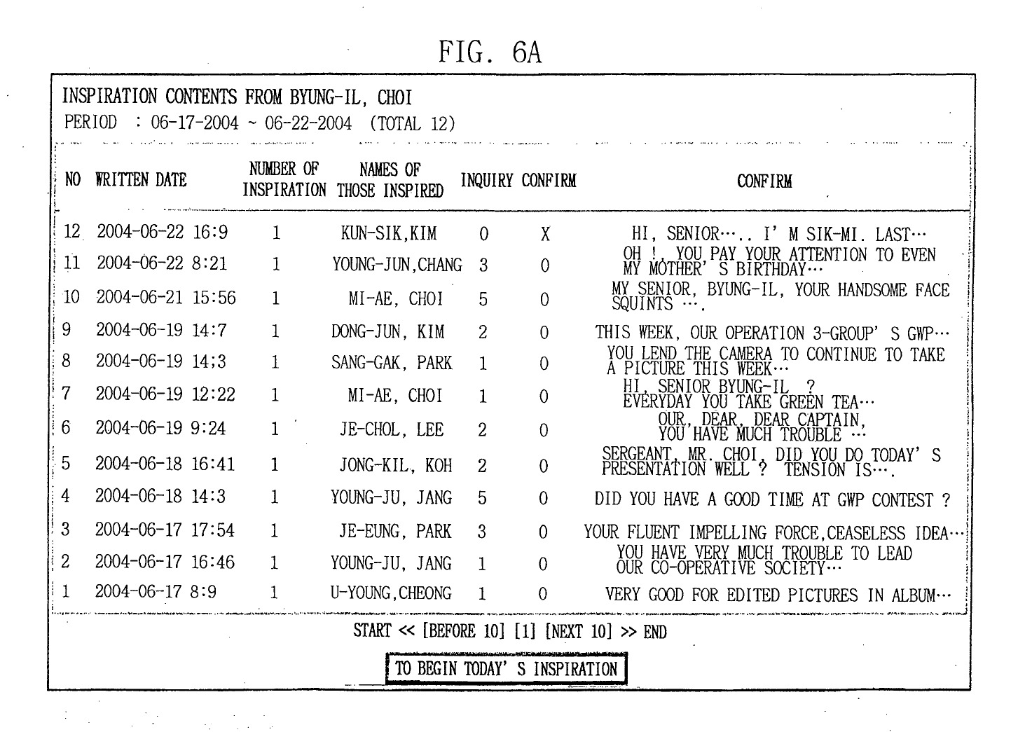

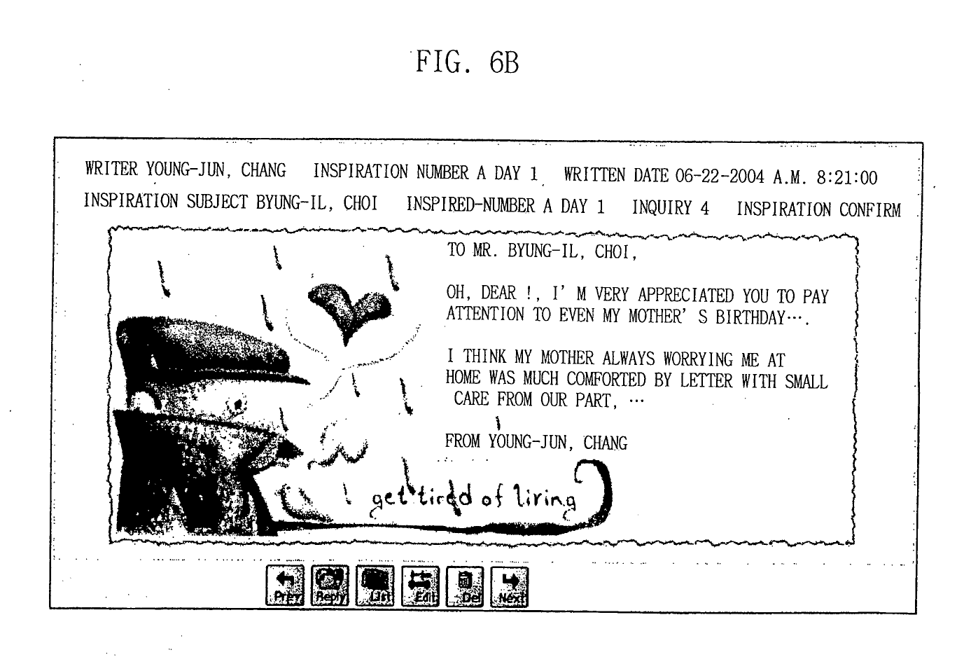

The user may now select to read an inspiration message addressed to the user. Once the message to be read has been selected (409). Then index server 40 retrieves related messages from inquiry information database 63, and displays the messages similar to the one shown in FIG. 6A (410). The user selects a specific message to read (411). Index server 40 displays on terminal 10 the message selected by the user retrieved from registration information database 62, and similar to the one shown in FIG. 6B (412). After reading the message, the user confirms reading the message. Once the message has been read, index server 40 registers the read message confirmation to inquiry information database 63 (413). As shown in FIG. 6A, the confirmation status of the message is represented as a counter in the form of O to X.

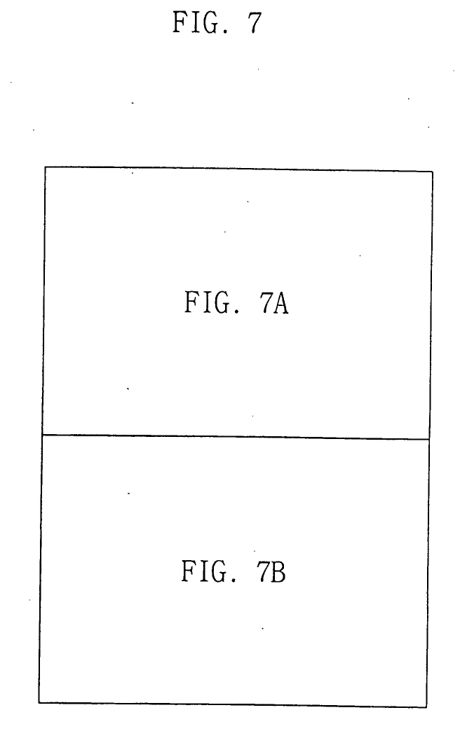

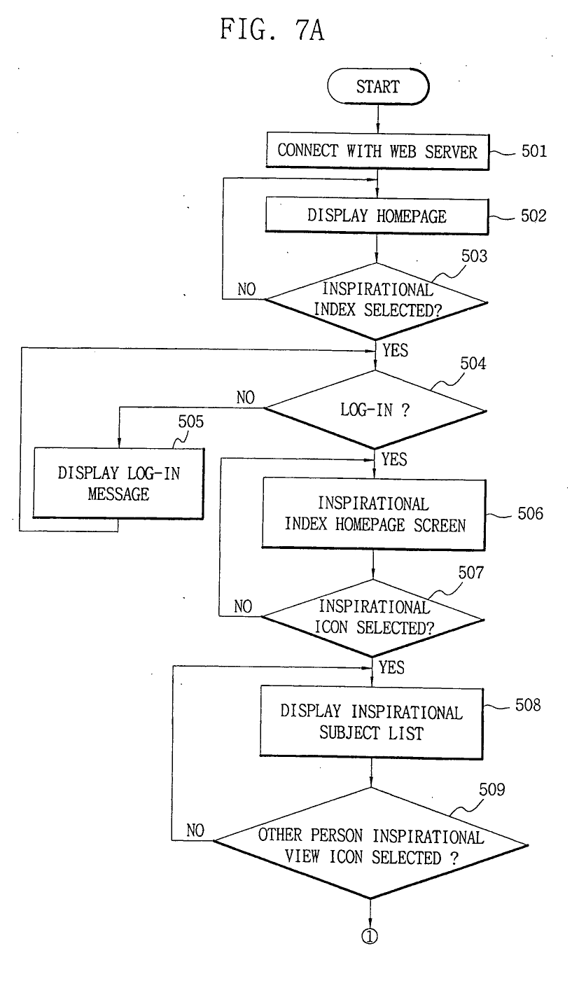

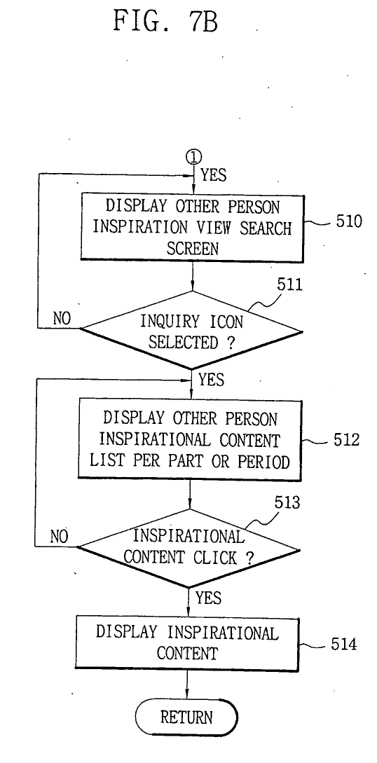

FIG. 7, comprising FIGS. 7A and &B, is a flowchart illustrating a method of confirming the receipt of inspirational message addressed to another person.

A user first connects to an inspirational message index associated, for example, with a homepage displayed on terminal 10 (510, 502). At this time, the user may select a screen icon associated with the inspirational message index. Upon receiving an indication that the inspirational message index icon has been selected, index server 40 next determines whether the user is appropriately logged-in (504). If not, a log-in message is displayed on terminal 10 (505). Where the user is logged-in, index server 40 displays the inspirational index homepage screen data on terminal 10 and retrieves related data form information database 62 (506). The screen display shown in FIG. 4A is one example of a possible inspirational index homepage screen.

At this time, the user may select a message icon from amongst a range of possible menus and lists appearing on the inspirational index homepage screen. One such message icon is generically referred to as a praise icon. When the praise icon is selected (507), the process continues and subject information corresponding to various messages (e.g., inspirational or positive feedback messages) is displayed on terminal 10 (508). This information may be retrieved, for example, from member information database 61. This subject information may be displayed, for example, in a manner like that shown in FIG. 4B.

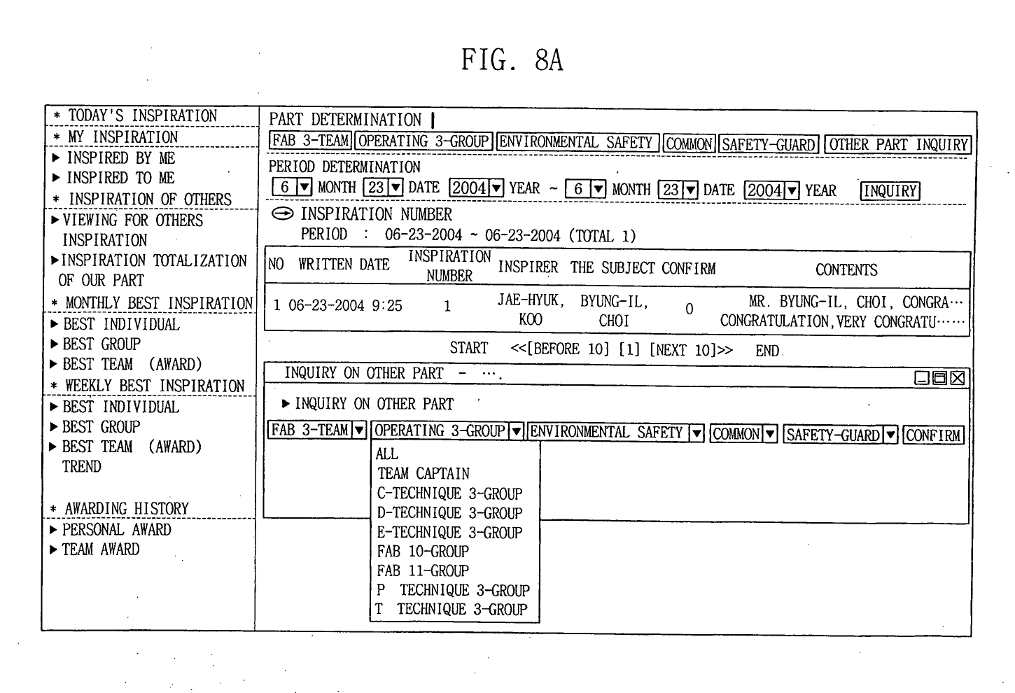

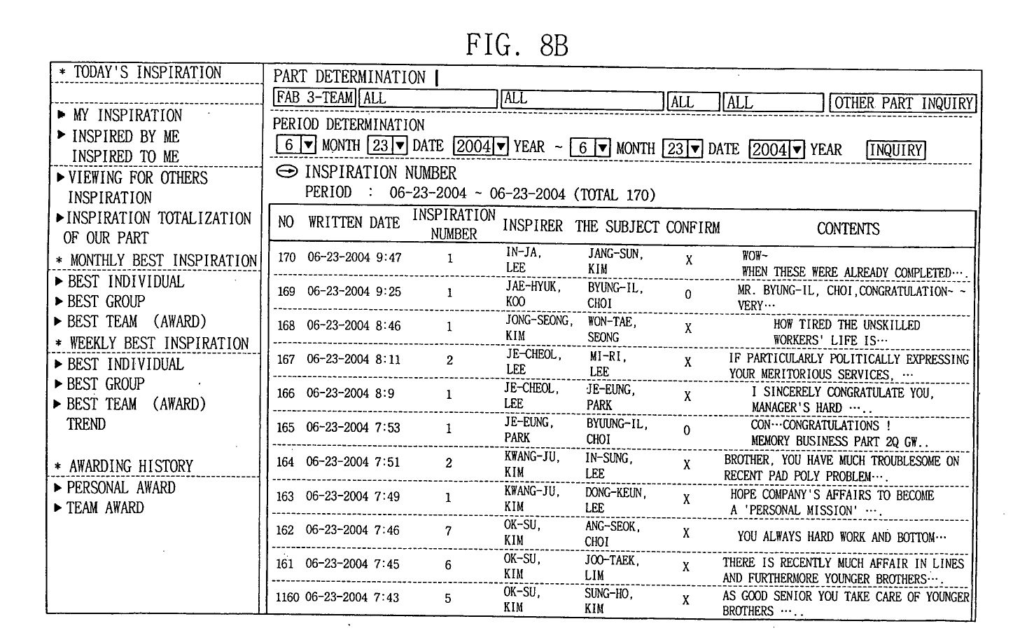

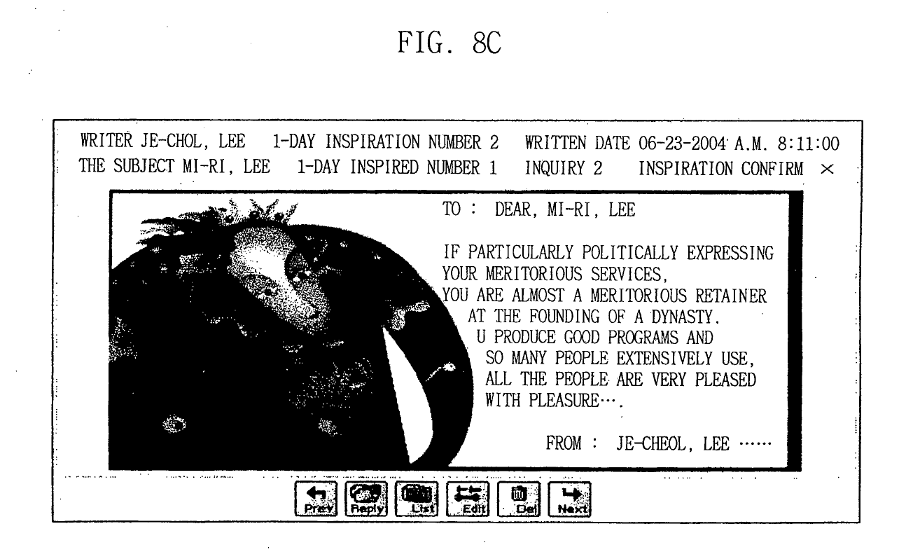

The user may now select to read a message addressed another person from the inspirational index service menu (509). Then index server 40 retrieves related messages from inquiry information database 63, and displays the messages similar to the one shown in FIG. 8A (510). The user selects a time period for which messages were received by another person. Retrieved from inquiry information database 63, index server 40 displays on terminal 10 the messages received during the specified period similar to the one shown in FIG. 8B (512). Then the user selects a specific message to read (513). Index server 40 retrieved from praise registration information database 62 the selected message and displays on terminal 10 similar to the one shown in FIG. 8C (514).

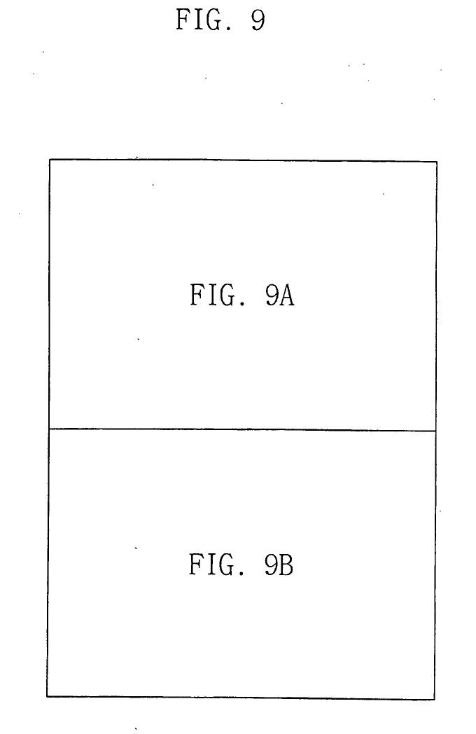

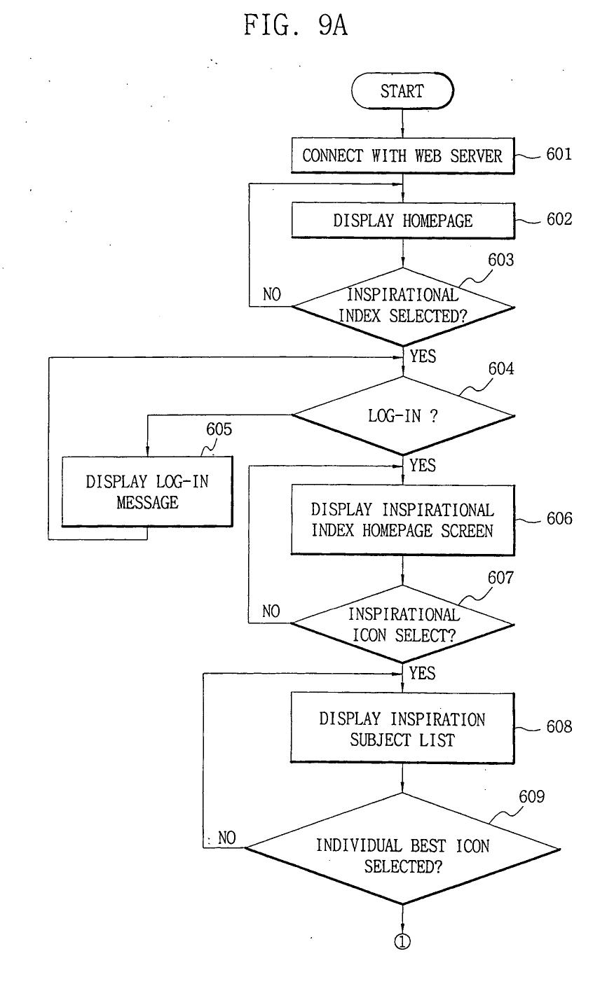

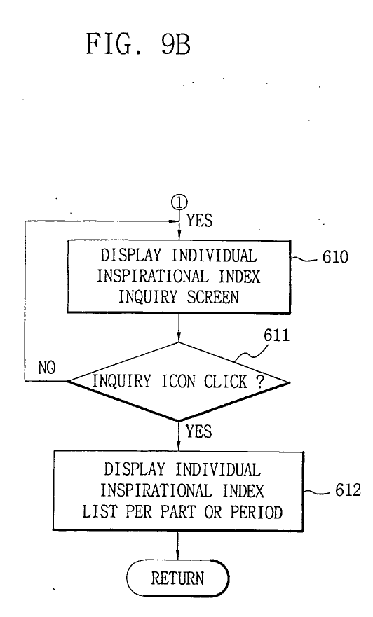

FIG. 9, comprising FIGS. 9A and 9B, is a flowchart illustrating a method of confirming an individual inspirational index.

A user first connects to an inspirational message index associated, for example, with a homepage displayed on terminal 10 (610, 602). At this time, the user may select a screen icon associated with the inspirational message index. Upon receiving an indication that the inspirational message index icon has been selected, index server 40 next determines whether the user is appropriately logged-in (604). If not, a log-in message is displayed on terminal 10 (605). Where the user is logged-in, index server 40 displays the inspirational index homepage screen data on terminal 10 and retrieves related data form information database 62 (606). The screen display shown in FIG. 4A is one example of a possible inspirational index homepage screen.

At this time, the user may select a message icon from amongst a range of possible menus and lists appearing on the inspirational index homepage screen. One such message icon is generically referred to as a praise icon. When the praise icon is selected (607), the process continues and subject information corresponding to various messages (e.g., inspirational or positive feedback messages) is displayed on terminal 10 (608). This information may be retrieved, for example, from member information database 61. This subject information may be displayed, for example, in a manner like that shown in FIG. 4B.

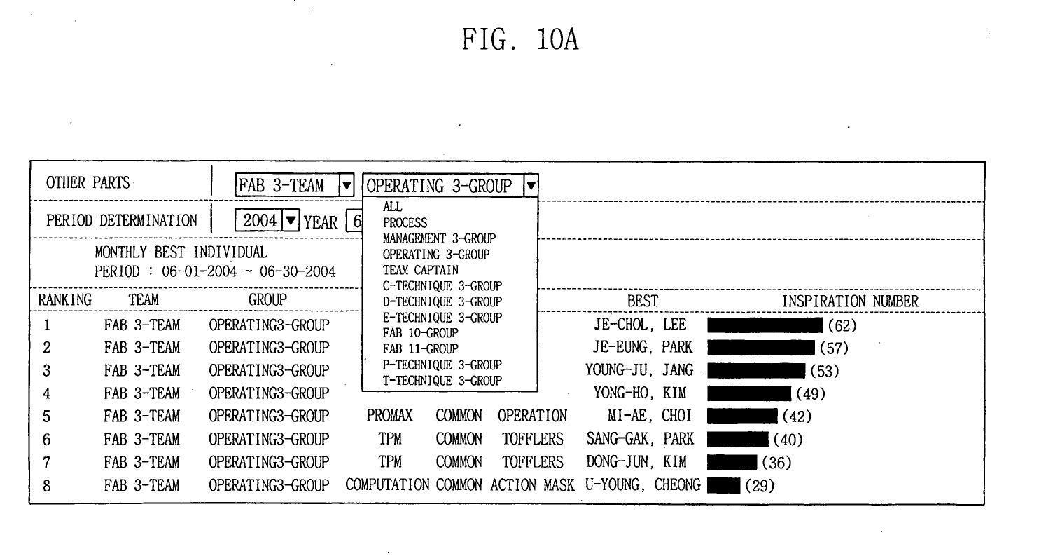

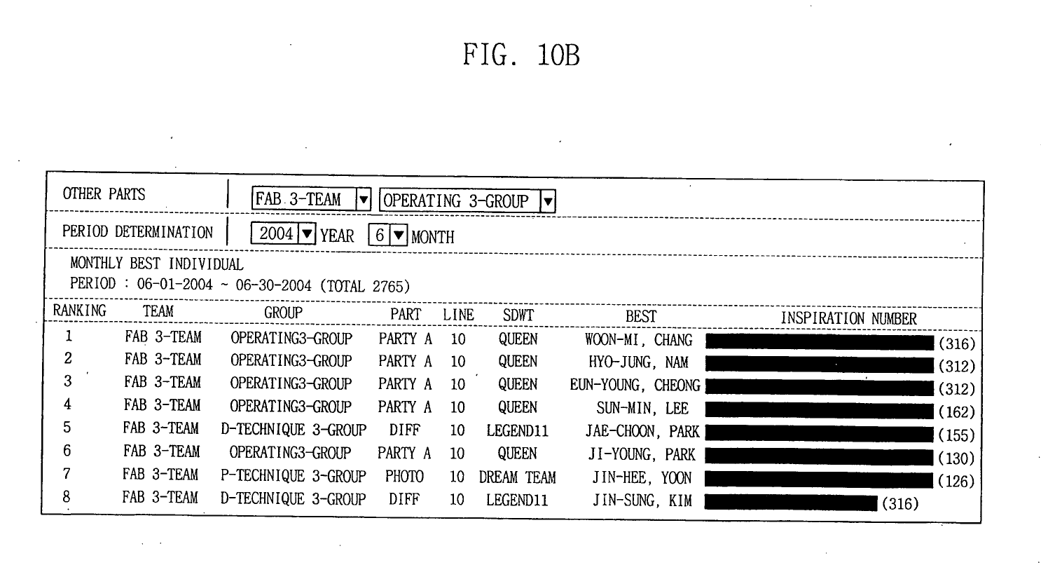

The user may now select an individual BEST icon from the inspirational index service menu (609). Index server 40 retrieved from inquiry information database 63 each individual inspirational index inquiry screen, and displays it on terminal 10 similar to the one shown in FIG. 10A (610). The user selects a specific period for a team, group, part, line or working party (611). Index server 40 retrieved from inquiry information database 63 and displays on terminal 10 individual inspirational index similar to the one shown in FIG. 10B (612).

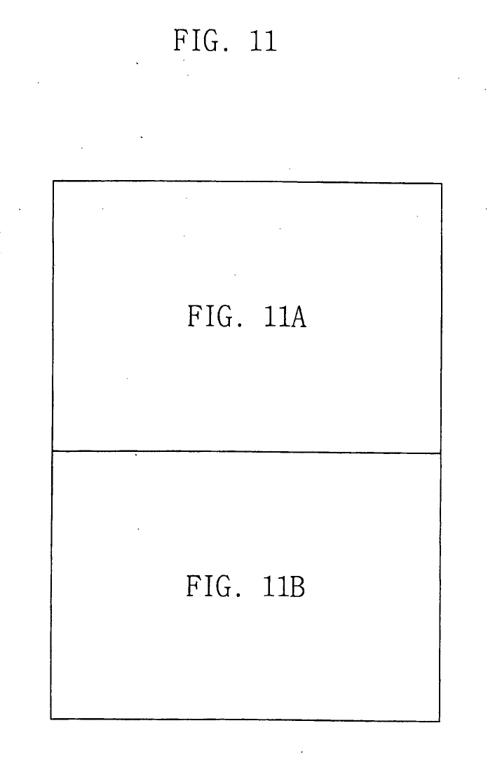

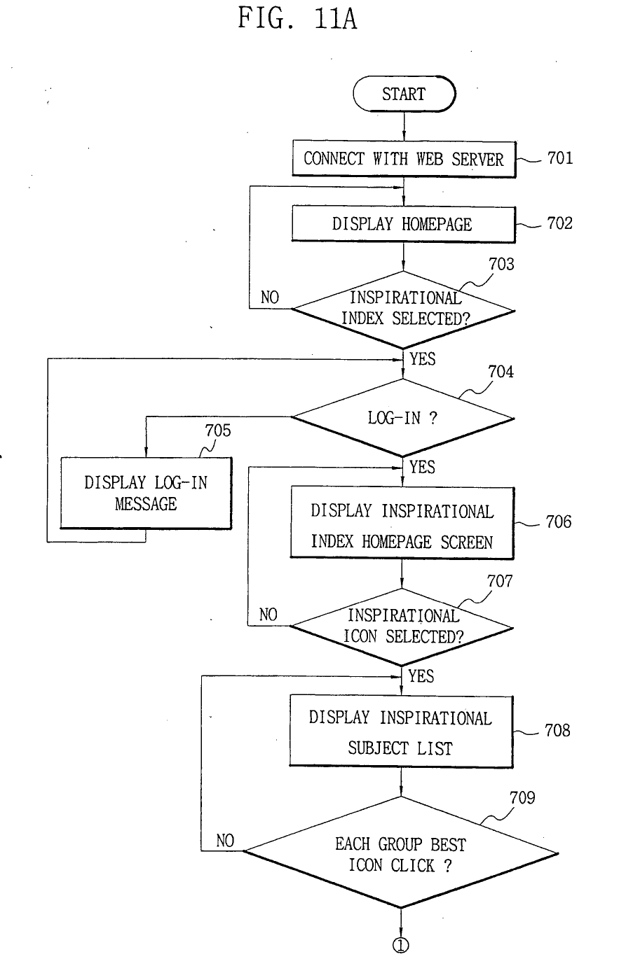

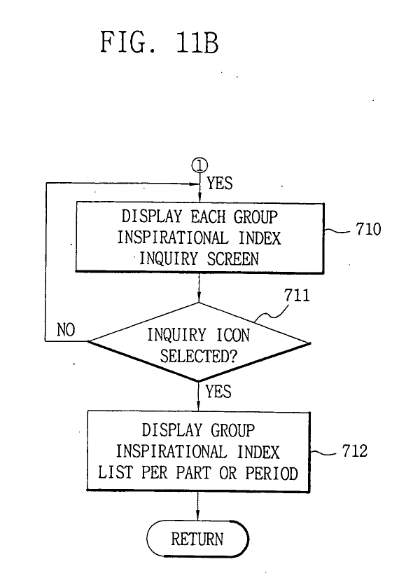

FIG. 11, comprising FIGS. 11A and 11B, is a flowchart illustrating a method of confirming a group inspirational index.

A user first connects to an inspirational message index associated, for example, with a homepage displayed on terminal 10 (710, 702). At this time, the user may select a screen icon associated with the inspirational message index. Upon receiving an indication that the inspirational message index icon has been selected, index server 40 next determines whether the user is appropriately logged-in (704). If not, a log-in message is displayed on terminal 10 (705). Where the user is logged-in, index server 40 displays the inspirational index homepage screen data on terminal 10 and retrieves related data form information database 62 (706). The screen display shown in FIG. 4A is one example of a possible inspirational index homepage screen.

At this time, the user may select a message icon from amongst a range of possible menus and lists appearing on the inspirational index homepage screen. One such message icon is generically referred to as a praise icon. When the praise icon is selected (707), the process continues and subject information corresponding to various messages (e.g., inspirational or positive feedback messages) is displayed on terminal 10 (708). This information may be retrieved, for example, from member information database 61. This subject information may be displayed, for example, in a manner like that shown in FIG. 4B.

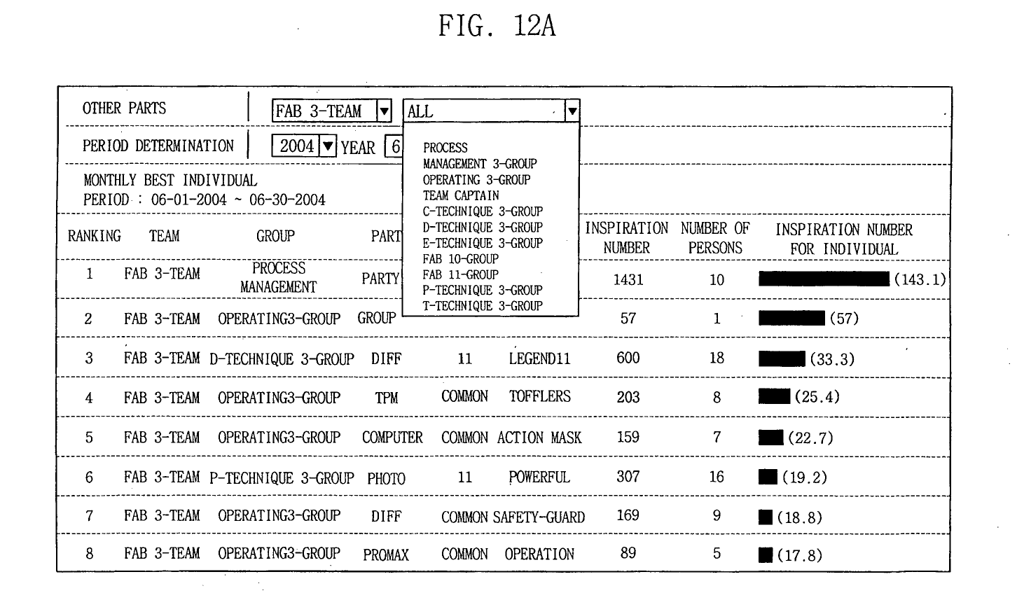

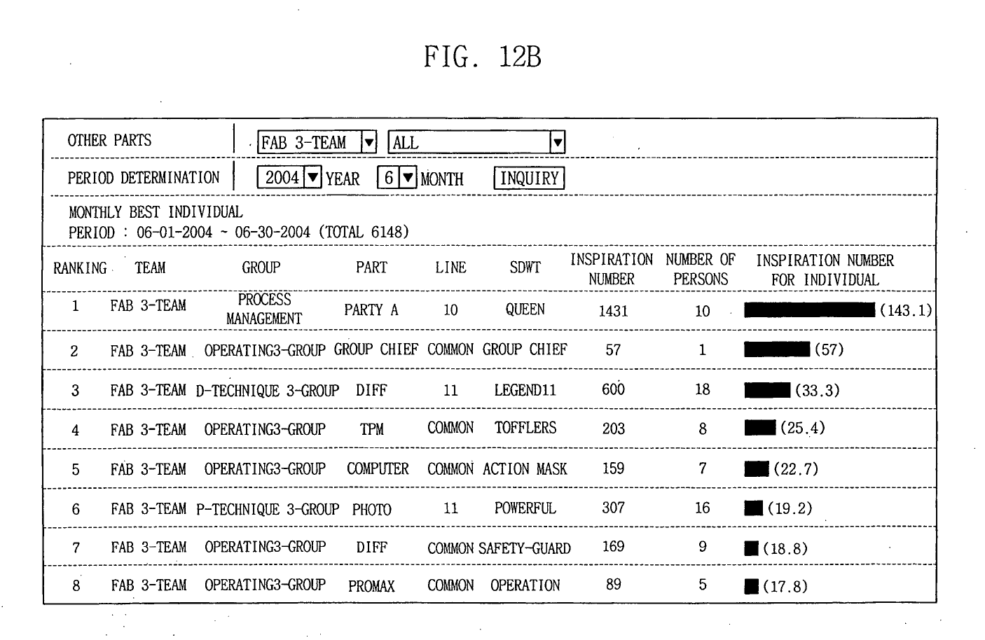

The user may no selects a group BEST icon displayed on the screen (709). Index server 40 retrieved from inquiry information database 63 the group inspirational index inquiry screen, and displays it on terminal 10 similar to the one shown in FIG. 12A (710). The user selects a specific period per a team, group, part, line or working party (711). Index server 40 displays on terminal 10 each group inspirational index corresponding to the selected part or period, similar to the one shown in FIG. 12B (712).

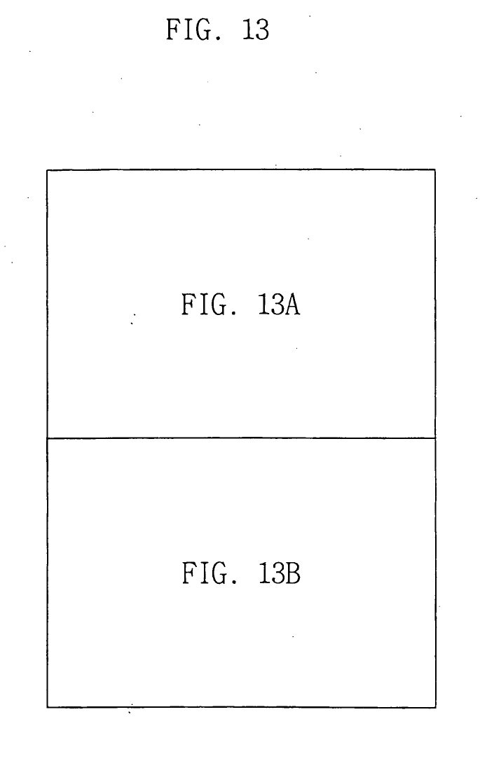

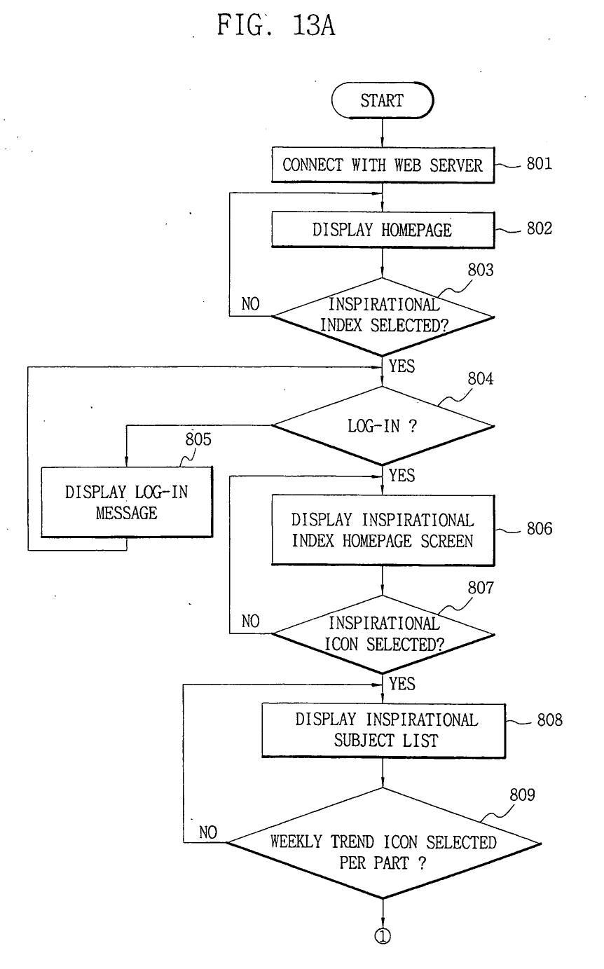

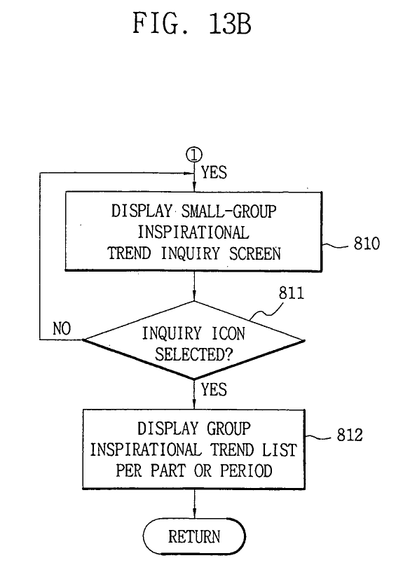

FIG. 13, comprising FIGS. 13A and 13B, is a flowchart illustrating a method of confirming each group inspirational message trend.

A user first connects to an inspirational message index associated, for example, with a homepage displayed on terminal 10 (810, 802). At this time, the user may select a screen icon associated with the inspirational message index. Upon receiving an indication that the inspirational message index icon has been selected, index server 40 next determines whether the user is appropriately logged-in (804). If not, a log-in message is displayed on terminal 10 (805). Where the user is logged-in, index server 40 displays the inspirational index homepage screen data on terminal 10 and retrieves related data form information database 62 (806). The screen display shown in FIG. 4A is one example of a possible inspirational index homepage screen.

At this time, the user may select a message icon from amongst a range of possible menus and lists appearing on the inspirational index homepage screen. One such message icon is generically referred to as a praise icon. When the praise icon is selected (807), the process continues and subject information corresponding to various messages (e.g., inspirational or positive feedback messages) is displayed on terminal 10 (808). This information may be retrieved, for example, from member information database 61. This subject information may be displayed, for example, in a manner like that shown in FIG. 4B.

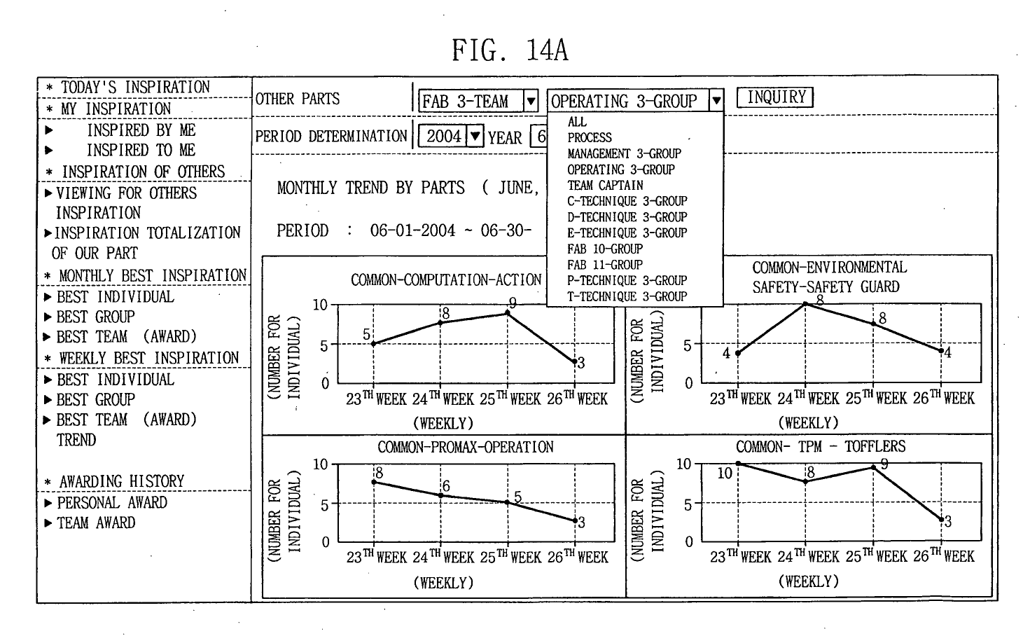

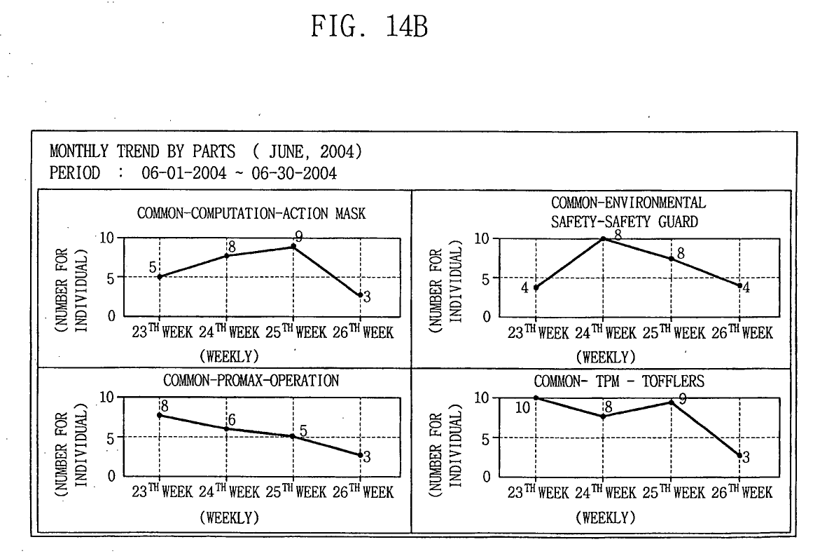

The user may now select a weekly TREND icon displayed on the screen (809). Index server 40 retrieved from inquiry information database 63 the weekly trend inquiry, and displays it on terminal 10 similar to the one shown in FIG. 14A (810). The user selects a specific period per a team, group, part, line, or working party (811). Index server 40 retrieved from inquiry information database 63 the weekly trend corresponding to the selected part or period, and displays it on terminal 10 similar to the one shown in FIG. 14B (812).

Although the weekly trend has been described above as an example, daily, monthly or yearly inquiry trend may also be selected.

The inspirational messaging among members of an organization may be implemented through an inspirational electronic network system described above, to reward prizes to individuals, team, group based on who receives the most praises, so as to stimulate production increase.

Some of the following trends have been noted by a major global company.

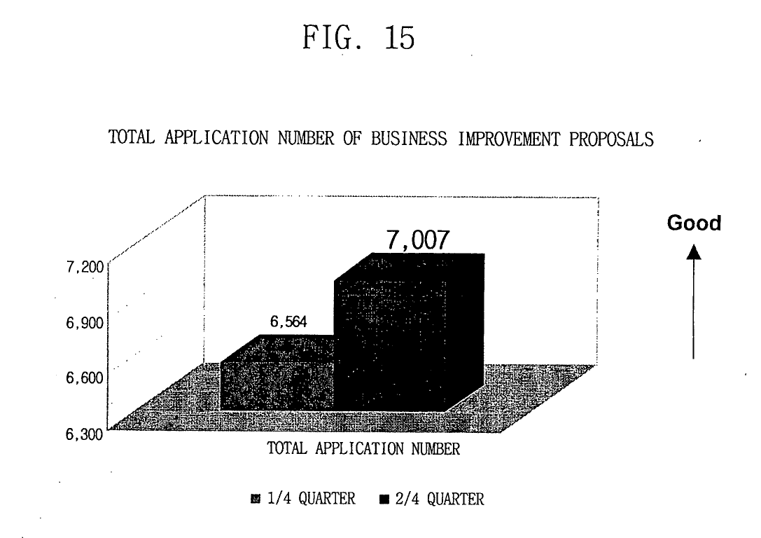

First, the total number of business improvement proposals increased by roughly 7% as shown in FIG. 15.

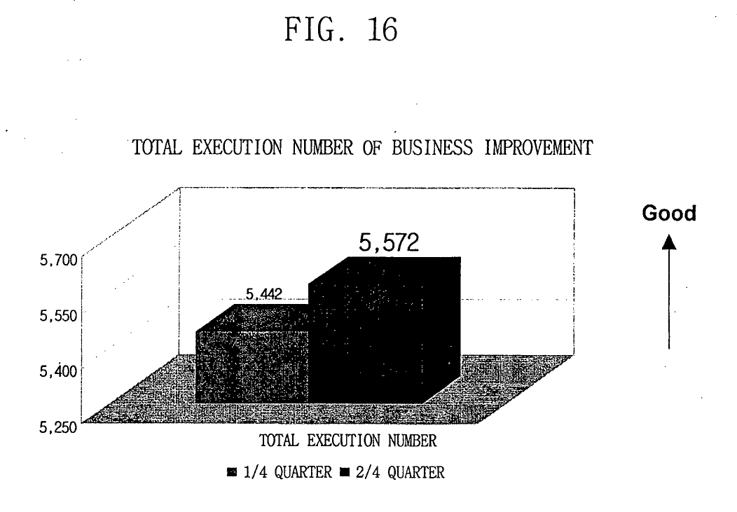

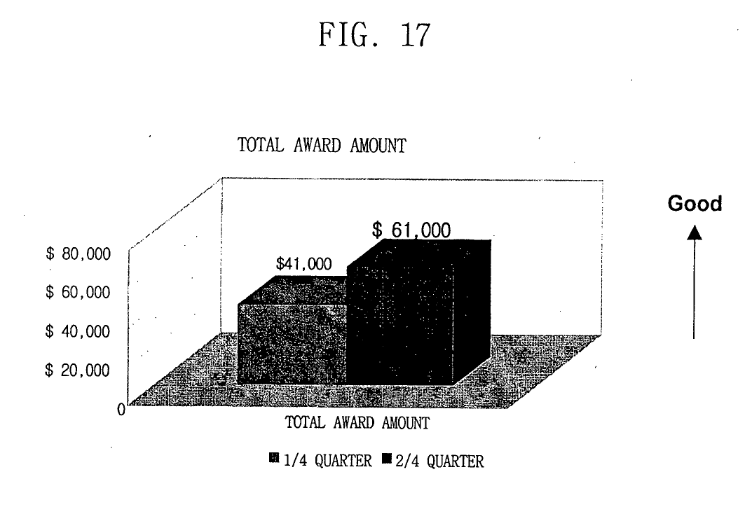

Second, the total number of implementation of the business improvement proposals increases by roughly 2% as shown in FIG. 16.

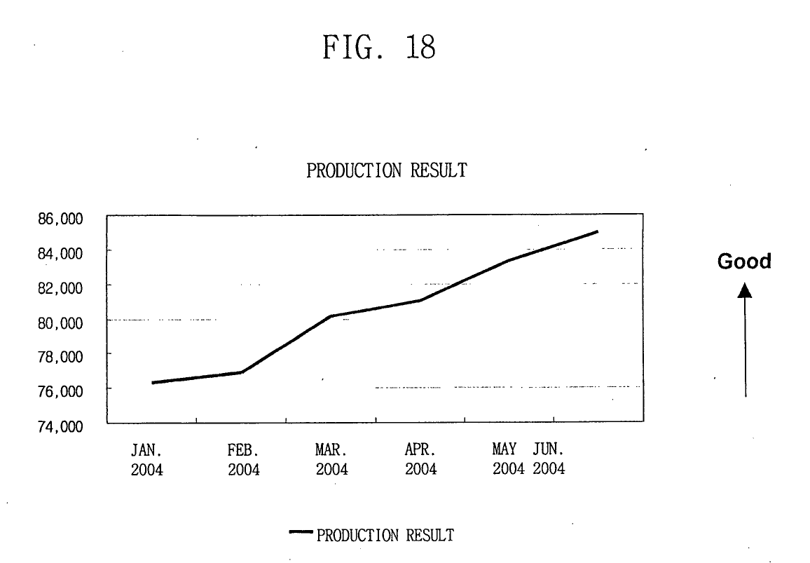

Third, the total amount of financial reward for implementing the business improvement proposals increases by 7% from $41,000 to $61,000 as shown in FIG. 18.

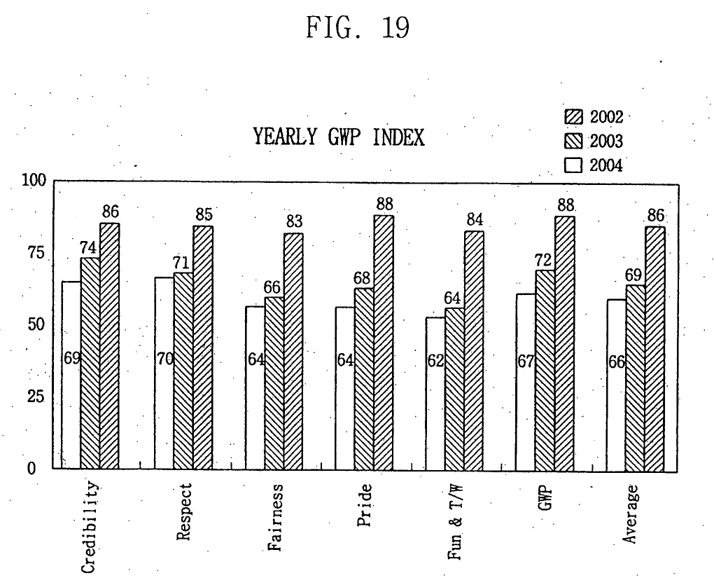

Fourth, production increase as a result of business improvement activities has increased by about 9% based on voluntary, cooperation, and originality of members as shown in FIG. 19.

Fifth, employee satisfaction increased by 80% after initiating GWP programs as shown in FIG. 20.

As described above, based on exemplary embodiments of the present invention, production in an organization increased by sending inspiration messages, such as gratitude, encouragement, and recognition among members of company via virtual space, thereby enhancing business efficiency and productivity.

Additionally, the recognition, praise, and encouragement among members helped establish mutual reliability, whereby providing advantages capable of establishing an innovation team in the organization through personal voluntary and originality, and mutual cooperation.

It will be apparent to those skilled in the art that modifications and variations can be made in the present invention without deviating from the scope of the present invention. Thus, it is intended that the present invention cover any and all such modifications and variations to the present invention.

What is claimed is:

1. A method of increasing productivity in an organization by providing a service adapted to share inspirational messages among members of an organization, the method comprising:
providing a first platform in communication with a second platform, wherein the second platform comprises an index server;
responsive to a first input by a user on the first platform displaying an introduction menu on the first platform; and,
responsive to a second input by the user on the first platform displaying an inspirational menu on the first platform.

2. The method of claim 1, wherein the service is provided via a web homepage.

3. The method of claim 2, wherein the index server comprises a web server adapted to manage a plurality of databases and the web homepage, and wherein the index server is responsive to the inputs by the user.

4. The method of claim 3, wherein the plurality of databases comprise an information database, registration information database, and inquiry information database.

5. The method of claim 1, wherein the first input is a request for a first time registration or a log-in.

6. The method of claim 1, wherein the second input is a request to provide an inspirational message write form, and the method further comprises storing an inspirational message inputted into the inspirational message write form by the user.

7. The method of claim 1, wherein the second input is a request to provide information related to a daily trend report, a weekly trend report, or a monthly trend report on a use of the service.

8. The method of claim 1, wherein the first and second platforms communicate with each other via an internet network or an intranet network.

9. A method of increasing productivity in an organization by providing a service adapted to share inspirational messages among members of an organization, the method comprising:
providing a first platform in communication with a second platform, wherein the second platform comprises an index server;
responsive to a first input by a user on the first platform displaying an introduction menu on the first platform;
responsive to a second input by the user on the first platform displaying an inspirational menu on the first platform; and,
responsive to a third input by the user on the first platform displaying a stored inspirational message.

10. The method of claim 9, wherein the index server comprises a web server adapted to manage a plurality of databases and a web homepage, and wherein the index server is responsive to the inputs by the user.

11. The method of claim 10, wherein the plurality of databases comprises an information database, registration information database, and inquiry information database.

12. The method of claim 9, wherein the stored inspirational message is a message addressed to the user.

13. The method of claim 9, wherein the stored inspirational message is a message addressed to another user.

14. A method of increasing productivity in an organization by providing a service adapted to share inspirational messages among members of an organization, the method comprising:
responsive to a first input by a user on a first platform communicating between the first platform to a second platform, wherein the second platform comprises an index server and a database;
displaying an introduction menu on the first platform, retrieved from the database responsive to a second input by the user on the first platform;
displaying an inspirational message write form, retrieved from the database responsive to a third input by the user; and
storing an inspirational message inputted by the user onto the inspirational message write form.

15. The method of claim 14, wherein the index server comprises a web server to manage the database.

16. The method of claim 14, further comprising retrieving from the database an inspirational message addressed to the user, and displaying the message on the first platform responsive to a fourth input by the user.

17. The method of claim 14, further comprising retrieving from the database an inspirational message addressed to another user, and displaying the message on the first platform responsive to a fourth input by the user.

18. The method of claim 14, further comprising retrieving from the database information regarding a daily trend report, a weekly trend report, or a monthly trend report on a use of the service, and displaying the service information on the second platform responsive to a fourth input by the user.

19. The method of claim 14, wherein the first input request is a first time registration request or a log-in request.

20. The method of claim 14, wherein the inspirational message is a message of praise, encouragement, recognition, or gratitude.
